(19) United States
(12) Patent Application Publication
(10) Pub. No.: US 2004/0050024 A1
(43) Pub. Date: Mar. 18, 2004

(54) Coating film for oil recovery and coating composition for forming the coating film

(76) Inventors: Atsushi Nishino, Osaka (JP); Yohei Kawaguchi, Osaka (JP); Masayuki Fujimori, Shiga (JP); Teruo Uchibori, Shiga (JP); Toshikazu Tamai, Shiga (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/466,737

(22) PCT Filed: Dec. 12, 2001
(86) PCT No.: PCT/JP01/10871

(30) Foreign Application Priority Data
Jul. 9, 2001 (JP) 2001271949

(51) Int. Cl. B01D 46/00

(52) U.S. Cl. 55/524

(57) ABSTRACT

A film is provided that can collect oils by causing oils to adhere thereto and enables the collected oils to be relatively easily washed and removed.

The invention relates to an oil collecting film used in a method for collecting oils by transferring oils onto the film, obtained through heat treatment of a coat of a coating composition comprising lithium silicate, sodium silicate and water.

### TECHNICAL FIELD

The present invention relates to an oil collecting film and a coating composition for the formation of the film. It further relates to an oil collecting method using the aforementioned film, a member comprising the aforementioned film and an oil collecting filter.

### BACKGROUND ART

Usually, the exhaust paths or peripheral members of equipment and devices for cooking are contaminated with an oily mist generated during the cooking. The removal of this oil contamination requires time and some technical expenditure. In particular, because that contamination reaches down to the small parts of the equipment as an oil mist, it is extremely difficult to remove it from there. Thus, the removal and cleaning of the oil contamination for the maintenance of the equipment becomes a burdensome task.

In this respect, and in order to hinder the adherence of oil contamination, technologies providing anti-fouling coatings for the surfaces of all kinds of members have been proposed. In particular, coatings of fluororesins having excellent anti-adhesive properties are widely used.

However, coatings of fluororesins have the problem of losing easily their anti-fouling ability with time. If their anti-fouling ability decreases, it becomes necessary to undertake the removal of the oil contamination. Moreover, fluororesins themselves are relatively expensive, so their cost is disadvantageous.

From the viewpoint of environmental protection, there is an increasing need for devising means for avoiding the discharge of oils out of equipment and facilities. Therefore, the development of technologies that allow the collection of oils by actively capturing them would be desirable for the environment.

### DISCLOSURE OF THE INVENTION

Thus, the development of environmentally superior technologies allowing a reduction of maintenance work in equipment caused by oil contamination is looked forward to.

Therefore, a main object of the present invention is to provide a film that collects oils by causing them to adhere thereto, and from which the collected oils can be washed and removed relatively easily.

The inventors carried out an intensive research in order to solve the problems in the conventional art, resulting in the present invention, which attains the aforementioned object based on a specific film having unique properties.

That is, the present invention relates to an oil collecting film, a coating composition for the formation of the aforementioned film, a method for the collection of oils using that film, a member formed by that film and an oil collecting filter as follows:

1. An oil collecting film that is used in a method for collecting oils by transferring oils onto the film, and is obtained through heat treatment of a coat of a coating composition comprising lithium silicate, sodium silicate and water.

2. The oil collecting film according to item 1, wherein the coating composition further contains silica.

3. The oil collecting film according to item 1 or 2, wherein the weight ratio of lithium silicate to sodium silicate is 8:2 to 2:8.

4. The oil collecting film according to any one of items 1 to 3, wherein the thermal treatment is carried out at a temperature ranging from 170 to 230° C.

5. A coating composition for the formation of the oil collecting film according to any one of items 1 to 4, comprising lithium silicate, sodium silicate and water.

6. A method for collecting oils characterised in that the oil collecting film according to any one of items 1 to 4 is brought into contact with oils.

7. The method for collecting oils according to item 6 characterised in that the film to which oils have been adhered is further brought into contact with water so that the oils adhered to the film are removed.

8. A member formed by a substrate having the oil collecting film according to any one of items 1 to 4 provided thereon.

9. An oil collecting filter comprising a sheet-shaped metal material having voids to allow the circulation of air therein and the film according to any one of items 1 to 4, wherein the film is formed on the surface of the metal material.

(1) Oil Collecting Film

The oil collecting film of the present invention is used in a method for collecting oils by bringing the film into contact with oils, wherein the film is obtained through heat treatment of a coat of a coating composition comprising lithium silicate, sodium silicate and water.

The film according to the present invention is appropriately used in specific applications involving a method for collecting oils by transferring oils onto the film. That is, in the present invention, oils are collected by actively causing them to adhere to the film, thereby making it possible to prevent or control the diffusion or dispersing of oils out of the system.

The kinds of oils are not restricted, in fact any type of oil may be appropriate. In particular, oils classified as cooking oils and edible oils are preferred. As specific examples of oil types, for instance, salad oil, sesame oil, lard oil, soybean oil, cottonseed oil, rapeseed oil, tallow, hardened oils, palm oil, etc. may be cited.

The film according to the present invention is formed by heat treatment of a coat of the above coating composition (i.e., the coating composition of the present invention). The coating composition of the present invention is a mixture comprising lithium silicate, sodium silicate and water.

As lithium silicate, common lithium metasilicate, etc. can be used. Herein products manufactured through conventional methods or commercial products can be used.

As sodium silicate, common sodium metasilicate (including also water glass), etc. can be used. Herein products manufactured through conventional methods or commercial products can be used.

In the present invention, the proportion of lithium silicate to sodium silicate may be adjusted as required, in accordance with the desired specific properties, etc. to be achieved; but usually the weight ratio ranges from about 8:2 to about 2:8, preferably from 7:3 to 3:7. By employing this range, even superior water resistance, etc. can be obtained.

The content of water is not limited, and can be appropriately determined as required by the above weight ratio and for achieving the objects in the use of the coating composition of the present invention. In general, water is added so that the solids content of the composition according to the present invention ranges from about 15 to about 60% by weight, preferably from 30 to 50% by weight. Within this range, particularly good film forming ability, etc. can be achieved.

The composition of the present invention may include further components other than the above, if necessary. For example, silica, coloring agents, etc. may be included in the formulation.

As for silica, conventional products or commercially available products can be used. The addition of silica can improve the qualities of the film, etc. The content of silica can be established appropriately according to desired characteristics, the above weight ratios, etc.; normally it is not larger than 50 parts by weight for 100 parts by weight of the sum of lithium silicate and sodium silicate, preferably not larger than 40 parts by weight. By adding silica in a range as mentioned in the above, the resulting film can be prevented certainly from blisters or the like.

Coloring agents are not restricted, and for instance conventional or commercially available pigments can be used. These pigments may be inorganic or organic. Inorganic pigments are, for instance, chromium oxide, copper oxide, bengal, titanium oxide, manganese dioxide, etc. Organic pigments are, for instance, cyanine blue, pigment brown, etc. The content of pigments is not restricted; normally it is not larger than 200 parts by weight for 100 parts by weight of the sum of lithium silicate and sodium silicate, preferably not larger than 100 parts by weight.

The composition of the present invention can be obtained by mixing homogeneously all these components. The mixing can be carried out in mixers, kneaders, mills and other appropriate conventional equipment.

Next, a coat of the composition of the present invention is formed and is then heatly treated. A coat may be formed by applying the composition of the present invention onto an adequate substrate.

The method itself for forming the coat is not restricted, for instance, brush coating, spray, roller coating, dipping, and other conventional coating methods can be employed.

The substrate is not particularly restricted, its material can be metal (alloys included), ceramic, a heat resistant plastic, a composite material of the foregoing, or any other material. In particular, metal materials (including alloys) are preferred. Specifically, for instance, a sheet-shaped metallic material having voids to allow the circulation of air, such as a wire mesh or a perforated metal plate can be used.

After the coat is formed, it is thermally treated. The heat treatment method can be any conventional heating method carried out in heating furnaces, muffle furnaces, ovens, etc. Far infrared irradiation can be also used as a heat treatment method.

The temperature of the heat treatment depends on the composition of the coating composition; normally it is 170° C. or higher, preferably from about 170 to 230° C. The duration of the heat treatment can be adjusted in accordance with the heat treatment temperature, etc. Herein, preferred rates of temperature increase up to the temperature of the above heat treatment range from about 0.5 to about 20° C./minute. Adjusting the rate of temperature increase, blistering of the film, etc. can be prevented more effectively.

In the present invention, drying can be carried out after the application of the coat, prior to the heat treatment. Drying may be natural drying or heating drying, but in the present invention, heating drying is preferred. Heating drying can be carried out using the above heating methods.

Also, in the present invention, the film may consist of 2 or more layers. Therefore, the above sequence of processes consisting of coat formation and drying can be carried out repeatedly 2 or more times.

The thickness of the film of the present invention can be adjusted according to the type and application of the product to be coated, desired adherence, etc.; it usually ranges from about 10 to about 30 μm.

(2) Method for Collecting Oils

The present invention comprises also a method for collecting oils wherein the oil collecting film according to the present invention is brought into contact with oils so that the oils adhere to the aforementioned film.

The method for contacting oils is not specifically restricted as long as oils can adhere to the film. For instance, the method can be established depending on the type and construction of the equipment, the locations where the oils are generated, etc. For example, in cooking equipment, it can be implemented by arranging a member, comprising an oil collecting film formed on the part or entirety of the surface of a sheet-shaped metallic material having voids to allow the circulation of air, in the exhaust path (exhaust hood intake, etc.). In this case, the member above acts as an oil collecting filter. Such members can also be obtained by forming the film according to the present invention on filters arranged in conventional cooking equipment.

In the present invention, oils can be washed and removed relatively easily by bringing the film to which oils has been adhered into contact with water. The method for bringing the above film into contact with water is not specifically restricted, it can be carried out for instance through immersion in water, water spraying, water brushing, etc. For example, oils can be removed by immersing in water every member having an oil collecting film for a specific lapse of time.

By means of the present invention, it is possible to provide a film with excellent adherence to oils. Therefore, the contamination by oil, etc. can be collected, allowing to prevent or control the diffusion or dispersion of oils out of the equipment. The collected oils can be re-used if necessary, so an effective utilisation of the oils can be devised.

Also, the oil collected by adhesion to the film can be easily removed with water. Moreover, the above film has excellent water resistance, therefore washing and removing oil contaminations etc. with water does not impair its adhesive capability after repeated uses.

Furthermore, in spite of the fact that the above film is composed mainly of inorganic materials, the film can avoids effectively the occurrence of superficial blistering or cracking, etc., contributing to maintaining good anti-fouling and water resistance properties for relatively long periods of time.

### BRIEF DESCRIPTION OF THE DRAWINGS

A drawing showing the reference shapes for evaluating the shape of oil drops in the experimental examples.

### BEST MODE FOR CARRYING OUT THE INVENTION

The present invention is explained more in detail by means of the examples and comparative examples below. The scope of the present invention is not meant to be limited to or by the scope of the examples.

### EXAMPLE 1

(1) Preparation of the Coating Composition

Lithium silicate (“LSS-35” from Nissan Chemicals) and sodium silicate (sodium silicate #2, from Toso Sangyo) are mixed in the proportions shown in Table 1 to prepare the coating compositions (samples \mathring{1} to \mathring{2}). Specifically, lithium silicate, sodium silicate and water were mixed for 2 hours in a propeller stirrer to prepare the coating composition. Water was added to obtain a solids concentration of 35% by weight.

TABLE 1

| | \mathring{1} | \mathring{2} | \mathring{3} | \mathring{4} | \mathring{5} | \mathring{6} |
|---|---|---|---|---|---|---|
| Lithium | 0 | 20 | 40 | 60 | 80 | 100 |
| silicate | | | | | | |
| Sodium | 100 | 80 | 60 | 40 | 20 | 0 |
| silicate | | | | | | |

Samples \mathring{1} and \mathring{6} in Table 1 were Reference Products

(2). Coating of the Substrate

The coating compositions obtained above were applied onto the substrate (aluminium “1050P H24”).

The above substrate was cut into pieces about 5 cm×10 cm×0.06 cm as specimen, which were degreased using commercial degreasing detergents, washed with water and dried prior to the application of the coating. Next, the specimens were dipped in the above composition, dried and were next heat-treated to form the film. The heat conditions were as follows. A temperature was raised from room temperature to 200° C. in 30 minutes, then the temperature was kept at 200° C. for a further 30 minutes. An oven was used for the drying and the heat treatment.

### EXPERIMENTAL EXAMPLE 1

The following tests were carried out on the films formed on each of the specimens. The results are shown in Table 2. Table 2 also shows the results of the tests carried out below, using for comparison a) aluminium plate, b) stainless plate, c) acrylic/melamine coated plate, d) fluororesin coated plate, e) enamelled plate, f) commercial product \mathring{1}, g) commercial product \mathring{2}. In Table 2, samples \mathring{1} and \mathring{6} are the reference products.

(1) Oil Adherence

One drop (approximately 0.025 g) of the oil to be evaluated (oil mixture of lard oil: salad oil with a weight ratio of 1:3 heated to 260° C. and then cooled to room temperature) was dropped gently with a micro-pipette onto the specimens, observing its shape and extension after 5 minutes.

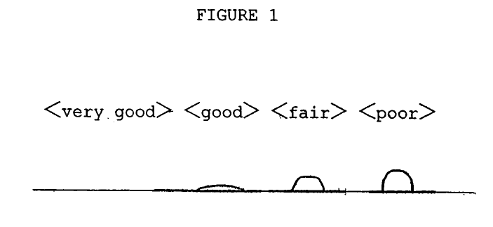

As for the extension of the oil drops, the largest and smallest diameters of the oil drops spreading ovally were measured by means of a calliper in order to calculate their area. The stronger the adherence of the oil is, the larger that area is. The shape of the oil drops was evaluated by comparing them with the 4 shapes in FIG. 1, which shows their cross sections, and were classed into the shape they resembled the most. The stronger the adherence of the oil is, the smaller the height of the drop is.

(2) Oil Removability

\mathring{1}—Initial Ability

The specimens were dipped in the above oils for evaluation for 30 seconds, in order for the oil to be evaluated to attach to the whole specimen. The specimens with the adhered oil for evaluation were immersed in tap water for 15 minutes, while observing the easiness with which oil was removed. Specimens where oil could be removed extremely easily were rated as “very good”, those where it could be easily removed as “good”, those where the oil could be only partially removed as “fair” and those where almost no oil could be remove as “poor”.

\mathring{2}—Durability

The specimens were immersed in tap water for 48 hours. Next, the specimens were removed, the water wiped off and then they were dried. Then the specimens were immersed in the above oils for evaluation for 30 seconds in order for the oil to be evaluated to adhere to the whole specimen. The specimens with the adhered oil for evaluation were immersed in tap water for 15 minutes, while observing the easiness with which oil was removed. Specimens where oil could be removed extremely easily were rated as “very good”, those where it could be easily removed as “good”, those where the oil could be only partially removed as “fair” and those where almost no oil could be remove as “poor”.

(3) Water Resistance The specimens were immersed in boiling water for 30 minutes, after which their appearance was observed visually. Those with no change all were rated as “very good”, those with almost no change as “good”, those where the film was partly damaged as “fair”, and those where the entire coating was damaged as “poor”.

TABLE 2

| | Oil adherence | | | | |
|---|---|---|---|---|---|
| Evaluation item | Area after | Shape after | Oil removability | | Water |
| Sample | 5 min. (mm²) | 5 min | Initial | Repeated | resistance |
| Aluminium plate | 83.4 | fair | poor | poor | very |
| | | | | | good |
| Stainless plate | 22. 8 | poor | poor | poor | very |
| | | | | | good |
| Acryl/melamine coated | 78.5 | fair | fair | fair | good |
| plate | | | | | |
| Fluororesin | 22.9 | poor | good | good | good |
| coated plate | | | | | |
| Enamelled plate | 73.8 | fair | good | good | good |
| Commercial product \mathring{1} | 86.4 | good | good | good | fair |
| Commercial product \mathring{2} | 109.3 | good | good | good | good |
| Sample \mathring{1} | Coating formation difficult | | | | |
| (baking at 200° C.) | | | | | |
| Sample \mathring{2} | 164.0 | very | very | very | very |
| (baking at 200° C.) | | good | good | good | good |
| Sample \mathring{3} | 178.9 | very | very | very | very |
| (baking at 200° C.) | | good | good | good | good |
| Sample \mathring{4} | 197.3 | very | very | very | very |
| (baking at 200° C.) | | good | good | good | good |
| Sample \mathring{5} | 192.9 | very | very | very | very |
| (baking at 200° C.) | | good | good | good | good |

| | |
|---|---|
| Sample \mathring{6} | Coating formation difficult |
| (baking at 200° C.) | |

The results in Table 2 show that the product according to the present invention has excellent adherence to oil (ability for collecting oils) and excellent oil removability.

### INDUSTRIAL APPLICABILITY

According to the present invention, it is possible to provide a film with excellent adherence to oils. Thus, it is possible to remove oil contamination or smears and to prevent or control the diffusion or dispersing of oils out of equipment. The collected oils can be re-used if necessary, so an effective utilisation of the oils can be devised.

Also, the oil collected by adhesion to the film can be easily removed with water. Moreover, the above film has excellent water resistance, therefore washing and removing oils etc. with water does not impair its adhesive capability after repeated uses.

The above film, furthermore, in spite of being composed mainly of inorganic materials avoids effectively the occurrence of superficial blistering or cracking, etc., contributing to maintaining good anti-fouling and water resistance properties for relatively long periods of time.

1. An oil collecting film used in a method for collecting oils by bringing the film into contact with oils, wherein the film is obtained through heat treatment of a coat of a coating composition comprising lithium silicate, sodium silicate and water.

2. The oil collecting film according to claim 1, wherein the coating composition further contains silica.

3. The oil collecting film according to claim 1 or 2, wherein the weight ratio of lithium silicate to sodium silicate is 8:2 to 2:8.

4. The oil collecting film according to any one of claims 1 to 3, wherein the heat treatment is carried out at a temperature ranging from 170 to 230° C.

5. A coating composition for the formation of the oil collecting film according to any one of claims 1 to 4, comprising lithium silicate, sodium silicate and water.

6. A method for collecting oils which comprises bringing the oil collecting film according to any one of claims 1 to 4 into contact with oils.

7. The method for collecting oils according to claim 6, further including the step of bringing the film to which oils have been adhered into contact with water so that the oils adhered to the film are removed.

8. A member comprising a substrate having the oil collecting film according to any one of claims 1 to 4 provided thereon.

9. An oil collecting filter comprising a sheet-shaped metal material having voids to allow the circulation of air therein and the film according to any one of claims 1 to 4, wherein the film is formed on the surface of the metal material.
